(19) United States
(12) Patent Application Publication
(10) Pub. No.: US 2007/0253562 A1
(43) Pub. Date: Nov. 1, 2007

(54) Method and apparatus for measuring characteristics of an audio system using a tapered chirp

(76) Inventor: Thomas D. Kite, Beaverton, OR (US)

Correspondence Address: William A. Birdwell;BIRDWELL & JANKE, LLP, 1100 SW Sixth Ave, Ste. 1400, Portland, OR, 97204, US

(21) Appl. No.: 11/413,866

(22) Filed: Apr. 27, 2006

(51) Int. Cl. H04R 29/00

(52) U.S. Cl. 381/58; 381/56

(57) ABSTRACT

An apparatus and method for measuring the characteristics of an audio system using a tapered chirp. A starting frequency and an ending frequency for a chirp signal during which the chirp signal has a constant envelope amplitude are determined for the audio system to be measured. An intermediate time duration during which the chirp signal has the constant envelope amplitude is determined for the audio system to be measured. A beginning envelope amplitude taper on time duration is also determined for the audio system to be measured. A chirp signal having the starting frequency, the ending frequency, the intermediate time duration, and the beginning envelope amplitude taper time duration is applied as an input to the audio system to be measured. The resulting output signal from the audio system to be measured is acquired to determine the characteristics of the audio system is acquired. A signal source for generating the chirp signal is provided. A chirp parameter selection mechanism is provided for determining the starting frequency, the ending frequency, the constant envelope amplitude time duration, and the beginning envelope amplitude taper on time duration. A signal acquisition device acquires an output signal from the audio system, and a signal processing device determines one or more response characteristics of the audio system to be measured based on the output signal and the chirp signal. Preferably, the frequency of the chirp signal changes exponentially.

### BACKGROUND OF THE INVENTION

1. Field of the Invention

This invention relates to measuring the characteristics of an audio system using a tapered chirp, particularly to tapering the chirp on and off, and to methods and apparatuses for constructing and applying the tapered chirp.

2. Description of the Related Art

It is common for tests and measurements to be made on many different types of audio systems to determine whether they are functioning as desired or needed, or simply to characterize the system. Audio systems comprise a wide variety of apparatuses, including without limitation analog audio amplifiers, mixers, recording and playback devices, and telephone channels, and digital audio processors, recording and playback devices, and communication systems. Test and measurement instruments typically apply a known audio stimulus to the input of an audio system, measure the output produced in response to the stimulus, and determine the system characteristics generally by comparing the output to the input. Characteristics of a channel of an audio system that may be determined are, for example, frequency response, phase distortion, and harmonic distortion, but many other characteristics can be determined depending on the circumstances. The linear characteristics can be determined by measuring the linear impulse response of the system, from which the linear characteristics can be derived.

In audio system test and measurement it is known that one particularly useful type of stimulus to use is a swept frequency signal that starts at a first, low frequency and ends after a short, definite time at a second, high frequency. This stimulus is known as a “chirp.” Using a chirp, the characteristics of an audio channel can be determined quickly over the full spectrum of the ideal channel pass band without being obscured by inter-modulation distortion. One type of chirp that can be used is a linear chirp, whose frequency varies linearly with time. Thus, a linear chirp may be described mathematically as follows:

$$x ( t ) = sin [ 2 π t ( {f}_{1} + \frac{( {f}_{2} - {f}_{1} ) t}{T} ) ]$$

where t is time;
x(t) is the stimulus signal as a function of time;
f₁ is the low, starting frequency, in Hz;
f₂ is the high, ending frequency, in Hz; and
T is the total length of the stimulus, in seconds.
   However, a linear chirp has the drawback that, while useful measurements of some characteristic can be made, harmonic distortion components in the output cannot be distinguished from one another.

Another type of chirp that can be used is an exponential, or log-swept sine, chirp, whose frequency varies exponentially with time. Thus, an exponential chirp may be described mathematically as follows:

$$x ( t ) = sin [ \frac{2 π {f}_{1} T}{ln ( {f}_{2} / {f}_{1} )} ( {( \frac{{f}_{2}}{{f}_{1}} )}^{t / T} - 1 ) ]$$

where t is time;
x(t) is the stimulus signal as a function of time;
T is the total length of the chirp, in seconds;
f₁ is the low, starting frequency, in Hz; and
f₂ is the high, ending frequency, in Hz.
   The exponential chirp has the important advantage that harmonic distortion components can be distinguished from one another. This is explained, for example, in T. Kite, Measurement of audio equipment with log-swept sine chirps, J. Audio Eng. Soc., vol. 53, p. 107 (2005 January/February). Consequently, the non-linear harmonic distortion characteristics, as well as the linear response characteristics, can be measured using an exponential chirp.

More specifically, it can be shown that:

$$t ( f ) = \frac{T}{ln ( {f}_{2} / {f}_{1} )} ln ( \frac{f}{{f}_{1}} )$$

where t(f) is the time at which a particular instantaneous frequency f appears in the chirp signal.
If the channel under test generates harmonic distortion such that when the input frequency is f, the harmonic distortion component in the output has a frequency Nf, where N is an integer harmonic, then the group delay of this distortion component is:

$$t ( f ) = \frac{T}{ln ( \frac{{f}_{2}}{{f}_{1}} )} ln ( \frac{f}{N {f}_{1}} )$$

so that each harmonic is offset in time from t(f) by:

$$Δ {t}_{N} = - T ( \frac{ln ( N )}{ln ( \frac{{f}_{2}}{{f}_{1}} )} )$$

Consequently, the non-linear harmonic distortion characteristics, as well as the linear response characteristics, can be measured using an exponential chirp.

A problem with the use of a chirp signal in audio system testing is that a transient effect may be generated when the chirp signal is turned on. Accurate measurements of the system in steady state cannot take place until after the transient effect has settled out. In addition, the sudden termination of the chirp produces unwanted frequency components that obscure to some extent a measurement of linear impulse response. This is manifested as “ripples” in the impulse response waveform.

Chirp stimuli, or signals, are used in seismic testing, as well as audio system testing, and it is known in the field of seismic testing that that a chirp signal may be tapered on and tapered off, typically using a cosine taper function, or window. Tapering of a seismic chirp signal is described, for example, in Jeffryes U.S. Patent Publication No. 2003/0093224 A1, published May 15, 2003; in Landrum, Jr. U.S. Pat. No. 4,567,583; and Edwards U.S. Pat. No. 4,202,048. However, these do not address audio system measurements, particularly any way of adapting the parameters of a tapered chirp for an audio system to be measured.

Accordingly, it would be desirable to have a method and apparatus for applying a tapered chirp signal to an audio system channel that enables the person controlling the testing to minimize any transient response of the channel to the chirp signal as appropriate for the particular audio system being tested and the particular test.

### BRIEF SUMMARY OF THE INVENTION

The present invention provides a method and apparatus for measuring the characteristics of an audio system using a tapered chirp signal. In the method, a starting frequency and an ending frequency for a chirp signal during which the chirp signal has a constant envelope amplitude are determined for the audio system to be measured. An intermediate time duration during which the chirp signal has the constant envelope amplitude is determined for the audio system to be measured. A beginning envelope amplitude taper on time duration is also determined for the audio system to be measured. These, or other, chirp parameters may be selected and the remaining chip parameters are determined from them. A chirp signal having the starting frequency, the ending frequency, the intermediate time duration, and the beginning envelope amplitude taper time duration is applied as an input to the audio system to be measured. The resulting output signal from the audio system to be measured is acquired while the chirp is applied and various measurements are made.

The apparatus provides a signal source for generating a chirp signal to be applied to an input of the audio system to be measured, the chirp signal having a starting frequency, an ending frequency, a constant envelope amplitude time duration, and a beginning envelope amplitude taper on time duration. A chirp parameter selection mechanism is provided for determining the starting frequency, the ending frequency, the constant envelope amplitude time duration, and the beginning envelope amplitude taper on time duration. The chirp parameter selection mechanism enables these, or other, chip parameters to be selected and automatically determines the remaining chirp parameters therefrom. A signal acquisition device is provided for acquiring an output signal from the audio system to be tested. A signal processing device is provided for determining one or more response characteristics of the audio system to be measured based on the output signal and the chirp signal.

It is to be understood that this summary is provided as a means of generally determining what follows in the drawings and detailed description, and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is a block diagram of a measuring apparatus according to the present invention connected to a channel of a representative audio system under test having an analog input and an analog output.

FIG. 2A is an illustrative waveform of an essentially constant-amplitude exponential chirp signal to be applied to the channel of the audio system under test shown to in FIG. 1.

FIG. 2B is an illustrative waveform of the output signal of the channel of the system under test shown in FIG. 1, produced in response to the chirp signal of FIG. 2A.

FIG. 3A is an illustrative waveform of an exponential chirp signal to be applied to the channel of the audio system under test referred to in FIG. 1 wherein the chirp signal is tapered on and tapered off in accordance with the present invention, but the signal does not start at a zero crossing.

FIG. 3B is an illustrative waveform of the output signal of the channel of the system under test referred to in FIG. 1, produced in response to the tapered chirp signal of FIG. 3A.

FIG. 4A is an illustrative waveform of an exponential chirp signal to be applied to the channel of the audio system under test shown in FIG. 1 wherein the chirp signal is tapered on and tapered off and the chirp signal starts at a zero crossing, in accordance with the present invention.

FIG. 4B is an illustrative waveform of the output signal of the channel of the system under test referred to in FIG. 1, produced in response to the tapered chirp signal of FIG. 4A.

FIG. 5 is a flow chart of an illustrative processor program for implementing a system according to the present invention.

### DETAILED DESCRIPTION OF ILLUSTRATIVE EMBODIMENTS

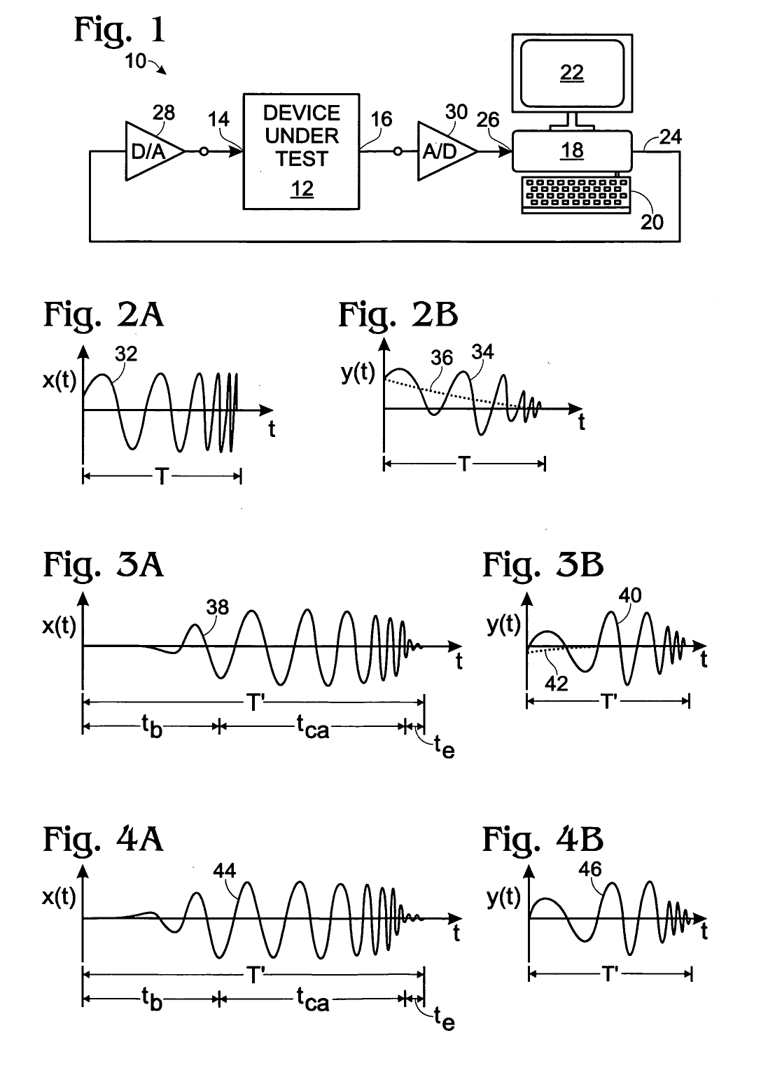

An illustrative embodiment of a test and measurement apparatus 10 for determining the characteristics of a representative audio system 12 is shown in FIG. 1. The representative audio system 12 under test (or the device under test, “DUT”) has one channel which has an analog input 14 and analog output 16; however, it is to be understood that an audio system to be tested may have multiple channels with respective inputs and outputs, and that the input and output signals could be digital or analog, or some combination of the two.

The test and measurement apparatus 10 comprises a digital processor 18, having an input device such as keyboard 20, an output device such as a visual monitor 22, a signal output port 24, and a signal input port 26. The processor is programmed to generate a tapered chirp test signal which is produced at the output port 24. It is to be recognized that the apparatus 10 may be adapted to test multiple channels of an audio system simultaneously, or essentially simultaneously; therefore, the apparatus may actually generate multiple chirp test signals simultaneously, or essentially simultaneously, for application to respective audio system channels.

In the illustrative case where the audio system has an analog input, the chirp test signal is applied directly to a digital-to-analog converter 28 that converts the chirp test signal to analog form for application to the analog input 14 of the audio system 12 under test. Where the audio system under test, or the particular channel of a multiple channel audio system, has a digital input, the digital-to-analog converter is unnecessary. As the illustrative audio system also has an analog output 16, the output signal from that system responsive to the chirp test signal is applied to an analog-to-digital converter 30 that converts the analog output of the system to digital form and applies it to the input port 26 of processor 18. Where the audio system under test, or the particular channel of the audio system, has a digital output, the analog-to-digital converter is unnecessary.

The processor 18 is programmed to produce chirp test signals as explained hereafter. Preferably, exponential chirp signals are used. It is also programmed to acquire the output signal from the DUT and produce a variety of selected measurements based on the applied chirp test signal and the responsive output signal, such as frequency response, phase distortion, and harmonic distortion, as will be understood by a person of ordinary skill in the art. In particular, the output signal is deconvolved, preferably using Fourier techniques, to determine the transfer function from which response characteristics may be determined. Using an exponential chirp, non-linear harmonic distortion components can then be distinguished from the linear transfer function so that harmonic distortion can be determined, as will be understood by a person of ordinary skill in the art.

However, without the benefit of the invention, the response characteristics will be somewhat obscured by transient components caused by the sudden onset and sudden termination of the chirp.

To understand the invention better, the effect of applying an exponential chirp x(t) of essentially constant amplitude starting at a random phase is illustrated by FIGS. 2(A) and 2(B). An essentially constant amplitude exponential chirp starting at a low starting frequency f₁ with a random phase, ending with a high ending frequency f₂, and having a total duration T is illustrated by waveform 32 in FIG. 2A. The output signal y(t) from the DUT is shown by waveform 34 in FIG. 2B. A typical system response envelope will have some low-frequency and high-frequency roll off, as shown by waveform 34; however, it can be seen that the response y(t) also has an approximately exponentially-decaying transient response component 36 added to the typical system response component. The response signal y(t) is acquired during time T to determine the DUT characteristics, so this transient response component adds unwanted frequency content to the acquired output signal that reduces the accuracy of channel characteristic measurements.

In accordance with the present invention, a chirp test signal 38 starting at a low onset frequency f₀, passing through the starting frequency f₁, passing through the ending frequency f₂, terminating at a final frequency f_{f}, and having a total time duration T′ is used, as shown in FIG. 3A. In this case, the chirp signal envelope amplitude tapers on during a beginning amplitude time duration t_{b}, is constant over an intermediate time duration time duration t_{ca}, from starting frequency f₁ to ending frequency f₂, and tapers off during an ending time duration tₑ. Because the chirp test signal envelope amplitude tapers on, the transient response component 36 in the output signal y(t) is greatly reduced. Also, because the test signal envelope amplitude is tapered off over tₑ, unwanted frequency components in the deconvolved output signal are greatly reduced.

Even if the chirp test signal envelope amplitude is tapered on, the responsive output signal y(t), shown by waveform 40 in FIG. 3B, will still have a transient component 42, albeit smaller. However, due to the random phase at the start of the chirp, that transient component is not reduced as much as it can be, all other things being equal. Therefore, in accordance with the invention, the chirp test signal is preferably forced to start at a zero crossing, as shown by waveform 44 in FIG. 4A. This further reduces the transient response, as shown by waveform 46 in FIG. 4B. While, in principle, the transient response cannot be entirely eliminated, it can be reduced to an acceptable level by increasing the beginning taper time t_{b}.

In either case, the output signals 40 and 46 shown in FIGS. 3B and 4B, respectively, are preferably acquired over the total time duration T′ and DUT characteristics, such as frequency response, harmonic distortion and phase distortion, are determined from them.

To achieve the optimum results made possible by the method and apparatus of the present invention, appropriate beginning envelope amplitude taper on and ending envelope amplitude taper off functions F_{b}(t) and Fₑ(t), respectively, must be chosen. A cosine squared envelope amplitude taper function has been found to work well, and is preferred, but other taper functions may be used without departing from the principles of the invention. The onset frequency f₀, the starting frequency f₁, the ending frequency f₃, the total time duration T′ of the chirp, the beginning time duration t_{b}, the constant envelope amplitude time duration t_{ca}, and the ending time duration tₑ, also must be properly chosen or determined. Increasing T′ produces a higher signal-to-noise ratio, but slows down the testing process. The starting and ending frequencies determine the measurement band. All other things being equal, making this band narrower increases signal-to-noise ratio, because the chirp test signal power is distributed over a smaller range of frequencies. Also, all other things being equal, making the beginning taper time longer reduces the corruption in the recovered response from the transient response. Preferably, the beginning taper time is selected so that it is at least as long as the time constant of the device, or channel, under test.

It is an important feature of the present invention that the only a few test parameters need to be chosen by the user and that the remaining parameters are computed based on the chosen parameters. Thus, for example, the user preferably chooses the lowest frequency of interest, that is, the starting frequency f₁; the highest frequency of interest, that is, the ending frequency fₑ; the time for the chirp signal to taper on, that is, the beginning time t_{b}, and the time that the chirp signal has a constant envelope amplitude, t_{ca}. Based on these choices, the onset frequency f₀, the total time duration T′, and the ending time tₑ are determined automatically by the processor 18. Preferably, the chirp signal starts at zero envelope amplitude and at a zero crossing (zero phase). Preferably, the response of the DUT to the chirp signal is acquired over the entire chirp duration T′ to ensure that the complete response is acquired. In some cases an extra acquisition time T′ₑ is chosen by the user to allow for response delay and ringing at the end of the time T′.

To facilitate parameter selection, the computer also is preferably programmed to produce a visual display indication of chirp test signal parameters on the monitor 22 to be selected by the user in any of many convenient ways known to a person of skill in the art. Once these are chosen, the computer generates the chirp signal, acquires the audio system output signal, and calculates and produces the desired measurements.

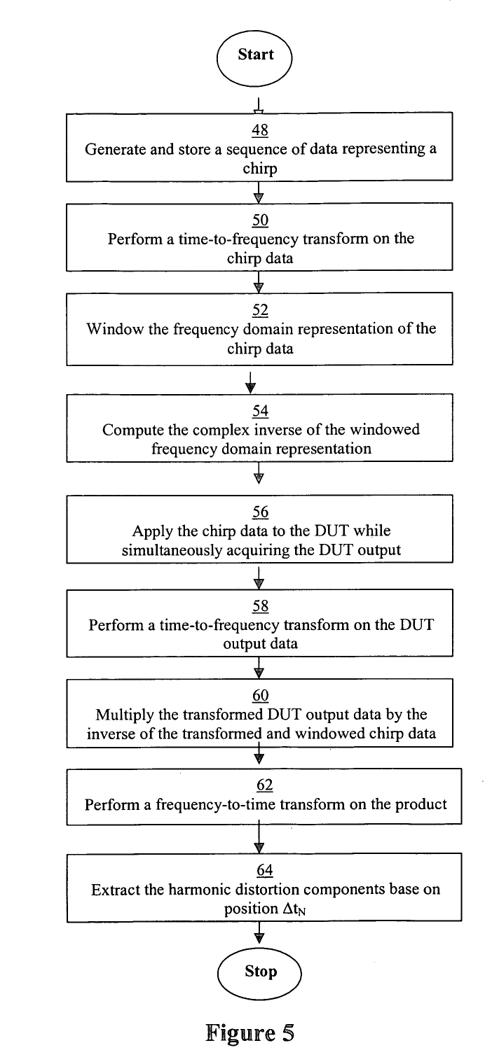

For example, as shown in FIG. 5, at 48, a chirp is generated based on selected parameters and stored as a sequence of data in the memory of the processor 18. At 50 the generated chirp data is transformed from the time domain to the frequency domain. At 52, the transformed, frequency domain representation of the chirp is windowed by an appropriate windowing function, to avoid having the inverse thereof become too large for frequencies outside f₁ and f₂ that have relatively low power. For example, a cosine-to-the-fourth-power windowing function applied to frequencies outside of f₁ and f₂ may be used and is preferred. At 54, the complex inverse of the transformed and windowed chirp is computed. The chirp data is applied to the DUT 12 and the output of the DUT is simultaneously acquired by processor 18, shown at 56. A frequency-to-time domain transformation is performed on the output signal at 58, and the transformed data is multiplied by the complex inverse of the transformed and windowed chirp data at 60. A frequency-to-time transform is performed on the product at 62 to reveal a time-domain impulse response. Finally, in the case of an exponential chirp, at 64 the harmonic distortion components are extracted from the impulse response according to their defined positions Δt_{N} in the impulse response as explained in the Description of Related Art above, ideally leaving only the linear impulse response.

It is to be understood that the foregoing steps are performed by digital processing and that the steps are described in terms of linear algebra using vector quantities. It is also to be understood that these steps are only representative of one way of programming a processor to achieve the desired result and that other steps and sequences of steps could be used without departing from the principles of the invention.

The terms and expressions that have been employed in the foregoing specification are used therein as terms of description and not of limitation, and there is no intention, in the uses of such terms and expressions, to exclude equivalents of the features shown and described or portions thereof, it being recognized that the scope of the invention is defined and limited only by the claims which follow

What is claimed is:

1. A method for measuring the characteristics of an audio system using a tapered chirp signal, comprising:
determining, for the audio system to be measured, a starting frequency and an ending frequency for a chirp signal during which the chirp signal has a constant envelope amplitude;
determining, for the audio system to be measured, an intermediate time duration during which the chirp signal has the constant envelope amplitude;
determining, for the audio system to be measured, a beginning envelope amplitude taper on time duration;
applying the chirp signal having the starting frequency, the ending frequency, the intermediate time duration, and the beginning envelope amplitude taper on time duration as an input to the audio system to be measured; and
acquiring an output signal from the audio system to be measured to determine the characteristics of the audio system.

2. The method of claim 1, further comprising determining a beginning envelope amplitude taper on function and applying the beginning envelope amplitude taper off function for the chirp signal.

3. The method of claim 2, further comprising starting the chirp signal at a zero crossing.

4. The method of claim 3, further comprising tapering the envelope amplitude of the chirp signal to zero after the intermediate time duration.

5. The method of claim 1, further comprising determining an ending envelope amplitude taper off function and applying the ending envelope amplitude taper off function to the chirp signal after the intermediate time duration.

6. The method of claim 5, wherein the ending envelope taper off function is a cosine squared function.

7. The method of claim 6, further comprising starting the chirp signal at a zero crossing.

8. The method of claim 1, further comprising starting the chirp signal at a zero crossing.

7. The method of claim 1, wherein the starting frequency, the ending frequency, the intermediate time duration, and the beginning taper time duration are selected, and an onset chirp frequency, final chirp frequency and total chirp duration are determined automatically.

10. The method of claim 9, wherein the chirp frequency changes exponentially from the onset of the chirp until the termination of the chirp.

11. The method of claim 9, wherein the envelope amplitude taper on function is a cosine squared function.

12. The method of claim 1, wherein the chirp frequency changes exponentially from the onset of the chirp until the termination of the chirp.

13. The method of claim 1, wherein the envelope amplitude taper function is a cosine squared function.

14. The method of claim 1, further comprising determining the frequency response of the audio system based on the output signal.

15. The method of claim 1, further comprising determining the harmonic distortion of the audio system based on the output signal.

16. The method of claim 1, further comprising determining the phase distortion of the audio system based on the output signal.

17. The method of claim 1, further comprising providing a visual display for selecting the starting frequency, the ending frequency, the intermediate time duration and the onset amplitude taper time duration.

18. An apparatus for measuring the characteristics of an audio system using a tapered chirp signal, comprising:
a signal source for generating a chirp signal to be applied to an input of an audio system, the chirp signal having a starting frequency, an ending frequency, an intermediate time duration during which the envelope amplitude is constant, and a beginning envelope amplitude taper on time duration;
a chirp parameter selection mechanism for determining the starting frequency, the ending frequency, the constant envelope amplitude time duration, and the beginning envelope amplitude taper on time duration;
a signal acquisition device for acquiring an output signal from the audio system to be measured; and
a signal processing device for determining one or more response characteristics of the audio system to be measured based on the output signal and the chirp signal.

19. The apparatus of claim 18, wherein the signal generator comprises a digital processor programmed to produce a digital form of the chirp signal and a digital-to-analog converter for converting the digital form of the signal to an analog form thereof for application to an input of the system under test.

20. The apparatus of claim 18, wherein the chirp parameter selection mechanism includes a data input mechanism for selecting the starting frequency, the ending frequency, the intermediate amplitude time duration, and the beginning envelope amplitude taper on time duration and for automatically determining therefrom an onset chirp frequency, a total chirp time duration, and an ending chirp time duration.

21. The apparatus of claim 18, wherein the signal acquisition device comprises an analog-to-digital converter for converting an analog signal output from the system under test to a digital representation thereof.

22. The apparatus of claim 18, wherein the signal source produces a chirp signal whose frequency varies exponentially.

23. The apparatus of claim 18, wherein the signal source initiates the chirp signal at zero envelope amplitude.

24. The apparatus of claim 23, wherein the signal source initiates the chirp signal at a signal zero crossing.

25. The apparatus of claim 18, wherein the signal source tapers the envelope amplitude on according to a cosine squared function.

26. The apparatus of claim 18, wherein the signal source initiates the chirp signal at a signal zero crossing.

27. The apparatus of claim 18, wherein the signal source tapers the chirp envelope amplitude to zero after the intermediate time duration.

28. The apparatus of claim 27, wherein the signal source tapers the envelope amplitude off according to a cosine squared function.

29. The apparatus of claim 18, wherein the signal processing device comprises a digital signal processor programmed to compute one or more response characteristics of the system under test.

30. The apparatus of claim 29, wherein the digital signal processor is programmed to compute the frequency response of the audio system based on the output signal and the chirp signal.

31. The apparatus of claim 29, wherein the digital signal processor is programmed to compute the harmonic distortion of the audio system based on the output signal and the chirp signal.

32. The apparatus of claim 29, wherein the digital signal processor is programmed to compute the phase distortion of the audio system based on the output signal and the chirp signal.

33. The apparatus of claim 18, further comprising a visual display for selecting the starting frequency, the ending frequency, the constant envelope amplitude time duration, and the beginning envelope amplitude taper on time duration.
